(19) United States
(12) Patent Application Publication
(10) Pub. No.: US 2025/0148277 A1
(43) Pub. Date: May 8, 2025

(54) ENTROPY-BASED ONLINE LEARNING WITH ACTIVE SPARSE LAYER UPDATE FOR ON-DEVICE TRAINING WITH RESOURCE-CONSTRAINED DEVICES

(71) Applicant: Dell Products L.P., Round Rock, TX (US)

(72) Inventors: Jonathan Mendes De Almeida, Brasília (BR); Renam Castro Da Silva, São José dos Campos (BR); Victor da Cruz Ferreira, Rio de Janeiro (BR)

(73) Assignee: Dell Products L.P., Round Rock, TX (US)

(21) Appl. No.: 18/501,409

(22) Filed: Nov. 3, 2023

(51) Int. Cl. G06N 3/08

(52) U.S. Cl. CPC G06N 3/08

(57) ABSTRACT

Techniques are disclosed for sparse layer-wise training of neural networks. An example system includes at least one processing device including a processor coupled to a memory. The at least one processing device can be configured to implement the following steps: obtaining class predictions while saving activations for only a number ‘k’ layers of a neural network, using the class predictions to calculate a layer shallowness measure for the neural network, using the layer shallowness measure to determine a number ‘u’ of layers to update in the neural network, and partially updating the neural network by training only the number ‘u’ layers of the neural network.

### FIELD

Example embodiments generally relate to machine learning and training machine learning models. More specifically, at least some embodiments relate to systems, hardware, software, computer-readable media, and methods for updating machine learning models using sparse layer-wise training.

### BACKGROUND

It is expected that in the upcoming years most of the world's enterprise-generated data will exist outside of the cloud environment. To harness such data and lay the groundwork for more intelligent industrial systems, machine learning (ML) solutions are expanding further into the resource-constrained edge where data abundance is tackled using devices with limited computing and communication resources. With that in mind, there is continuing interest in expanding solutions to support different edge environments and Internet of Things (IoT) use cases. These environments vary greatly in resource availability, which may limit on-device training capabilities.

### SUMMARY

Techniques are disclosed for sparse layer-wise training of neural networks.

In an embodiment, a system includes at least one processing device having a processor coupled to a memory. the at least one processing device being configured to implement the following steps: obtaining class predictions while saving activations for only a number ‘k’ layers of a neural network, using the class predictions to calculate a layer shallowness measure for the neural network, using the layer shallowness measure to determine a number ‘u’ of layers to update in the neural network, and partially updating the neural network by training only the number ‘u’ layers of the neural network.

In some embodiments, the layer shallowness measure is an adaptive partial model backpropagation measure. The layer shallowness measure can be determined dynamically as the neural network is retrained. The layer shallowness measure can be determined dynamically by detecting drift in the neural network. The drift can be detected using entropy values determined based on classes predicted by the neural network. The number ‘u’ of layers to update can be determined using the entropy values. The number ‘u’ of layers to update can be determined by dividing the entropy values into a plurality of ranges, and determining a count of entropy values that fall into each range. ‘K’ and ‘u’ can be fewer than all layers of the neural network. The activations can be saved for the last ‘k’ layers of the neural network. The neural network can be trained using sparse training to update the last ‘u’ layers of the neural network. The at least one processing device can be further configured to implement the following steps: after partially updating the neural network, updating the number ‘k’ to have the value of the number ‘u’. The steps can be performed on a resource-constrained device. The resource-constrained device can be an edge node of an edge network. The neural network can be a classifier model.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIGS. 1 and 2 disclose aspects of an example sparse layer-wise training framework, in accordance with illustrative embodiments.

FIG. 3 discloses aspects of an example feed-forward phase, in accordance with illustrative embodiments.

FIG. 4 discloses aspects of an example layer shallowness determination, in accordance with illustrative embodiments.

FIG. 5 discloses aspects of an example layer count determination, in accordance with illustrative embodiments.

FIG. 6 discloses aspects of an example entropy histogram, in accordance with illustrative embodiments.

FIG. 7 discloses aspects of an example sparse training, in accordance with illustrative embodiments.

FIG. 8 discloses a flowchart of an example method, in accordance with illustrative embodiments.

FIG. 9 discloses aspects of a computing entity configured and operable to perform any of the disclosed methods, processes, and operations, in accordance with illustrative embodiments.

### DETAILED DESCRIPTION

Example embodiments generally relate to machine learning and training machine learning models. More specifically, at least some embodiments relate to systems, hardware, software, computer-readable media, and methods for updating machine learning models using sparse layer-wise training.

Disclosed herein are techniques for sparse layer-wise training. In particular, example embodiments present an active online learning framework with an adaptive layer-wise updating mechanism driven by a layer shallowness measure. In some embodiments, the layer shallowness measure is the entropy of the model's prediction. The present solution is tailored to enable training on resource-constrained edge devices. Some embodiments leverage outside information using a layer shallowness approach that leverages an entropy-based determination to update the network parameters while decreasing memory and computation footprint.

It is expected that in the upcoming years most of the world's enterprise-generated data will exist outside of the cloud environment. To harness such data and lay the groundwork for more intelligent industrial systems, Machine Learning (ML) solutions are required to expand further into the resource-constrained edge where data abundance is tackled using devices with limited computing and communication resources. With that in mind, there has been continuing interest in expanding solutions to support different edge environments and Internet of Things (IoT) use cases. These environments vary greatly in resource availability, which may limit on-device training capabilities.

To provide intelligence to highly constrained IoT devices at the resource-constrained edge, conventional solutions focus on deploying compressed and pre-trained “frozen” ML models, e.g., the model is not updated after deployment on the device. However, in the presence of concept drift, due to the environment, changes can negatively impact a deployed model by degrading its performance. It turns out ML models can easily go outdated due to the data dynamicity of the edge environments, thus calling for technical solutions tailored for setups with stringent constraints on computation power and communication to deal with performance degradation.

Therefore, any technical solutions that benefit and improve ML execution while fulfilling the constraints of resource-constrained edge application scenarios directly benefit edge and IoT scenarios.

Within that context, technical problems with executing ML in constrained edge environments are highlight below:
Continuous communication overhead with the cloud to update ML models
Limited number of training techniques to support on-device training in constrained IoT scenarios
Minimizing overfitting during continuous training of IoT ML models at the edge

Disclosed herein is a framework with a sparse update mechanism that is directly driven by a layer shallowness measure. Example embodiments of the layer shallowness measure include determining an entropy of a given model's predictions. The present mechanism allows model updates only under relevant environment changes, while only performing partial network training in order to save resources at the edge. Example embodiments provide a technical solution as follows:
An entropy-based online learning framework with an active sparse layer update mechanism based on environment changes for training on resource-constrained devices

Disclosed herein is a technical solution to the above-identified technical problems in the form of an entropy-based online learning framework with an active sparse layer update mechanism based on environment changes for training on resource-constrained devices. In example embodiments, aiming at decreasing resource usage, the disclosed techniques introduce an adaptive partial model backpropagation procedure. The number of layers trained is set dynamically based on a layer shallowness measure, such as but not limited to the entropy of the classification network, which is a helpful mechanism to properly adapt the model to the environment changes. This mechanism evaluates the confidence predictions of the network in a set, and it can effectively evaluate the occurrence of concept drift during runtime. Advantageously, attaching the training procedure to the drift detector enables a smart adaptive training capability which follows data behavior.

The benefits of the present framework are many. For example, first, example embodiments enable continuous training without overfitting the network because the network avoids requiring thorough updates for every sample. Second, example embodiments avoid a need to communicate with the cloud in order to get model updates and the present framework consumes less memory and computational resources by performing partial updates, enabling on-device training for constrained resourced scenarios, and making the present framework well suited for a broad range of IoT use cases.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

Considering the resource constraints of edge and Internet of Things (IoT) devices, conventional ML solutions mainly focus on model compression and optimization of the inference process. In such a scenario, the model is not updated after deployment on the device. Nonetheless, on-device learning approaches have gained attention recently aiming at provisioning better personalization. Recent works present online learning approaches to provide on-device adaptive solutions based on neural networks. However, conventional solutions are restricted to updating a fixed layer, limiting the adaptation of the model to respond to and deal with environment changes. On the other hand, updating the complete model passively at each iteration imposes a high computational burden to resource-constrained edge devices and making the model more prone to catastrophic forgetting.

Passive adaptation leads to the need to constantly store intermediate activations required for backpropagation, increasing memory footprint and energy consumption. Considering that optimizing memory usage and energy consumption are helpful to provide intelligence for IoT devices at the edge, updating ML models in a passive manner may not be well suited for on-device model adaptation in such highly constrained scenarios. Additionally, fully adapting to every input may impose catastrophic forgetting and harm the model's performance.

Advantageously, in this context the disclosed techniques fill these gaps by providing an active adaptation mechanism, which is helpful for proper model adaptation according to the dynamicity of edge scenarios.

Deep learning techniques share common characteristics, such as the huge number of parameters and the highly energy consuming procedure to find optimized parameters' values. The spread of pervasive devices culminated in a demand for ML solutions at the resource-constrained edge to bring intelligence for IoT devices. Enabling intelligence as close as possible to data generation is helpful to support real-time applications, increase the system lifetime and Quality-of-Service. Nonetheless, there are severe constraints on memory, computation, and energy consumption for these edge devices. For instance, the memory capacity of IoT units usually ranges from Kilobytes to Megabytes, and the energy consumption should be in the order of milliwatts. Therefore, there is a need to reduce resource usage particularly for use cases at the resource-constrained edge.

In order to deal with the challenge of providing intelligence in highly constrained edge devices, most recent works are mainly focused on compressing ML models to perform inference in highly constrained environments, while the adaptability of these models is left aside. Considering the ever-changing scenarios that these devices are inserted, ML models can easily face severe performance degradation. Therefore, maintaining models updated at the resource-constrained edge is helpful and there is still room in improving the adaptative process of updating ML solutions on the edge device.

To tackle the above challenges, the disclosed techniques provide an entropy-based online learning framework with an active sparse layer update mechanism based on environment changes for on-device training on resource-constrained devices.

### B. Overview of Aspects of an Example Embodiment

Example embodiments present an active online learning framework with an adaptive layer-wise updating mechanism driven by the model's prediction entropy. The present solution is tailored to enable training on resource-constrained edge devices. Some embodiments leverage outside information using a layer shallowness approach that leverages an entropy-based determination to update the network parameters while decreasing memory and computation footprint.

The present sparse layer-wise training framework supports the use case where a pre-trained neural network is deployed on a resource-constrained edge device and needs to be continuously updated to withstand concept drift and catastrophic forgetting. In example embodiments, the present framework is divided into 4 phases, which are described in further detail herein.

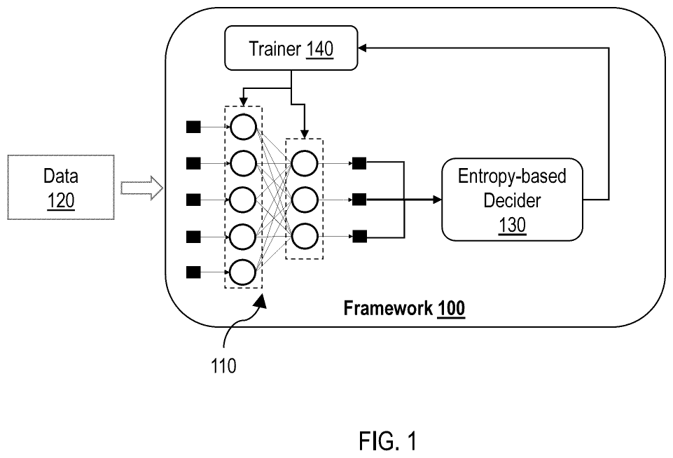

FIG. 1 shows aspects of an example sparse layer-wise training framework 100, in accordance with illustrative embodiments. In general, FIG. 1 shows an overview of components for the sparse layer-wise training framework.

Disclosed herein is a training framework 100 for resource-constrained scenarios that leverages a sparse layer-wise training procedure. The training procedure is specialized for saving memory and computation resources which is particularly useful for, but not limited to, resource-constrained edge use cases. Advantageously, the present training framework leverages a layer shallowness determination to adaptively control the model training and avoid model overfitting while learning in dynamic scenarios that are highly susceptible to the presence of concept drift. In example embodiments, the layer shallowness determination is an entropy-based evaluation algorithm.

The disclosed techniques support any enterprise solutions that deploy ML and may be deliverable at the edge (e.g., within edge environments and edge networks). One example area where the present framework can be deployed is to enhance storage products with artificial intelligence (AI). By way of example and not limitation, the disclosed techniques can improve similar solutions deployed at constrained edge environments and that require continuous on-device training. Such solutions will need to properly use the devices' resources and avoid overfitting while learning from never-before-seen data distributions.

FIG. 1 shows an overview of the sparse layer-wise training framework sparse layer-wise training framework 100. In example embodiments, general components of the framework include: (i) a classification neural network 110 that receives data 120 from within or outside the edge device, and (ii) an entropy-based decider 130 configured to evaluate the output of the network and inform the trainer 140 how to proceed with the sparse update. Since all training is performed inside the device, the framework also decreases the communication overhead with the cloud. It should be noted that the framework supports the path of many edge ML solutions whereby a neural network model is initially setup, trained and optimized at the cloud, and ported into the edge device. Furthermore, some embodiments of the framework leverage and enhance a continuous training pipeline where the model is constantly updated after deployment.

In example embodiments, operation of the sparse layer-wise training framework 100 is divided into four general phases:
1. In Phase 1, the data 120 is fed directly into a classification deep neural network (DNN) 110 that outputs prediction probabilities for each class and the feed-forward process is executed.
2. In Phase 2, the entropy-based decider 130 computer the entropy values based on the output of the SoftMax layer received from the classification neural network.
3. In Phase 3, a mechanism to select the number of layers to be updated is executed. In some embodiments, bins are determined based on the entropy values computed in Phase 2, to illustrate operation of the present framework.
4. In Phase 4, the trainer 140 executes a sparse training update based on the entropy bins created in Phase 3.

Each phase 1-4 is described in further detail, herein.

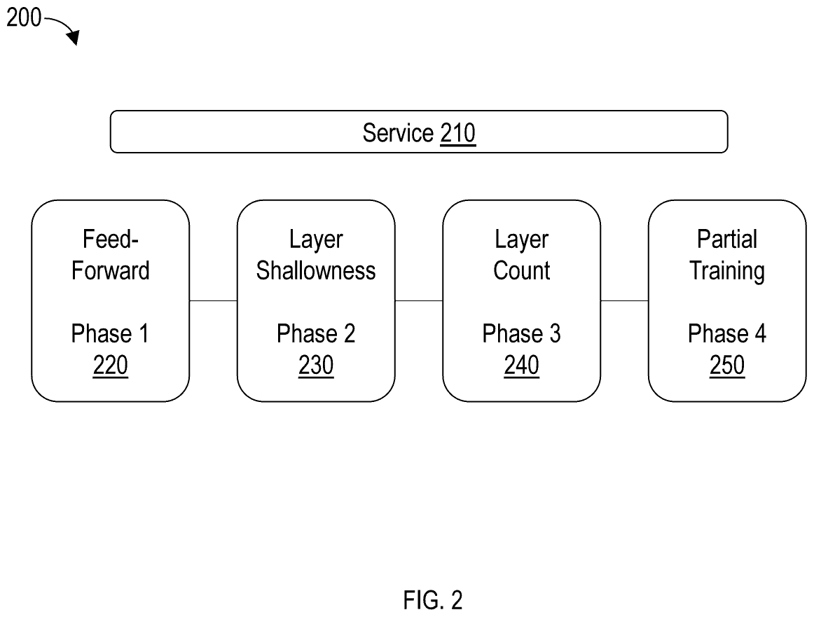

FIG. 2 shows aspects of an example sparse layer-wise training framework 200, in accordance with illustrative embodiments. In general, FIG. 2 illustrates the sparse layer-wise training framework 200 (an example of the sparse layer-wise training framework 100) configured to execute phases 1-4.

In example embodiments, a service 210 can implement the present sparse layer-wise training techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used herein, reference to any type of machine learning or artificial intelligence may include any type of machine learning algorithm or device, artificial neural network(s), convolutional neural network(s), deep neural network(s), multilayer neural network(s), recursive neural network(s), decision tree model(s) (e.g., decision trees, random forests, and gradient boosted trees) linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations.

In some implementations, the service 210 is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

### Phase 1 220—Feed Forward/Inference:

During conventional feed-forward passes, it is common to save the activations for every intermediate output, in order to carry out the backpropagation pass.

Example embodiments of the framework 200 take advantage of this activation approach, but only keep activations for the last k layers. For illustrative purposes, if k=1, then only the last hidden layer activations would be saved.

The following are example steps performed in this phase:
Data is fed into the classification model for prediction
Save activations for k layers
Externalize the class prediction probabilities for entropy computation

### Phase 2 230—Layer Shallowness:

In example embodiments, this phase uses an entropy computation to determine layer shallowness. This phase generally aims to provide a measure to drive the decision on how shallow or deep the framework 200 should carry out backpropagation. For this purpose, example embodiments evaluate the entropy of the network predictions produced in Phase 1. More particularly, some implementations calculate entropy as the negative value of the summation of the class prediction probability times its log value for all available classes. Therefore, this phase is designed to calculate the entropy using the class prediction probabilities for samples in the batch or stream.

The intuition is that when a model revisits a learned pattern, the model will likely produce a confident prediction, with probability mass concentrated in the correct class. In this case, the model's prediction will render a low entropy measure. On the other hand, when a sample presents features that depart from what the model has learned, the model is likely to produce an even prediction probability over the classes, thereby leading to a high entropy measure.

### Phase 3 240—Select a Number of Layers to be Updated:

In example embodiments, for this phase, the framework divides the entropy values into L bins, where L is the number of layers in the classification network. Each bin is associated with an entropy range and contains the number of samples in the batch that fell within the bin range. The bin with the highest number of samples is reported to the training module as the number u of layers to train.

Advantageously, this phase helps to link the drift detection output with the sparse training.

### Phase 4 250—Sparse Training Update:

In example embodiments, this phase starts the sparse training procedure. In some implementations, the framework 200 performs backpropagation training in only the last u layers. Advantageously, the amount of computation and memory can be decreased by only partially updating the neural network, which is helpful for highly resource-constrained devices. The general intuition is that whenever a concept drift occurs, example embodiments adapt the network more thoroughly to learn the new information better. At the same time, the framework avoids overfitting by updating the network less when drift is unlikely.

Example steps of this phase are detailed as follows:
Compare k and u
   If k≥u, all activations are already available that will be used for the backward pass
   If k<u, the disclosed techniques perform another forward pass, up until the missing activations are available for the u−k missing layers
Proceed with backpropagation training for (only) the last u layers
Update k to u for the next iteration

By following the example phases disclosed in this section, the framework 200 allows for training a classification neural network that is suitable for highly resource-constrained edge devices.

### C. Detailed Description of Aspects of an Example Embodiment

### C.1 Phase 1—Feed-Forward Process

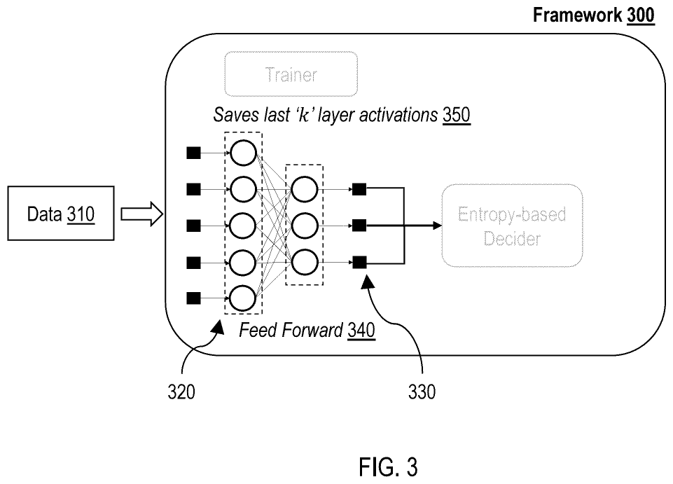

FIG. 3 shows aspects of an example feed-forward phase 300, in accordance with illustrative embodiments. In general, FIG. 3 shows an overview of the phase 1 process.

In example embodiments, this phase 300 represents the start of the present pipeline. Data 310 (an example of the data 120) is fed directly into a classification DNN 320 (an example of the neural network 110) that outputs prediction probabilities 330 for each class. In some implementations, the data is processed in batches.

Phase 1 generally performs a feed forward 340 over the network 320 while saving some layer activations 350.

Traditionally during this forward pass it is a common practice in conventional frameworks to store intermediate activations when training is expected to happen after the pass. For example, one reason activations are kept is to accelerate gradient calculation during the backward pass, otherwise it would be required to calculate the same values again.

Example embodiments improve the storage of intermediate activations in order to reduce memory usage and improve computation efficiency.

In example embodiments, the phase 300 keeps activation for the last k layers, where 1≤k≤L, and L is the total number of layers in the classification network 320. Advantageously, it should be noted that deciding to store k<L activations operates to decrease the overall memory footprint, by electing to refrain from storing L−k activations. This memory footprint reduction is helpful for execution of the present sparse layer-wise training framework in resource-constrained devices.

### C.2 Phase 2—Entropy Computation

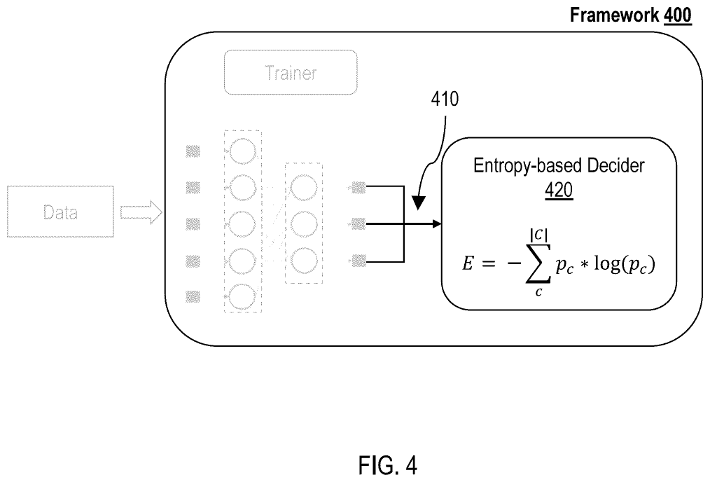

FIG. 4 shows aspects of an example layer shallowness determination 400, in accordance with illustrative embodiments. In general, Phase 2 uses output 410 from the classification network to calculate entropy.

Example embodiments of the entropy-based decider 420 carry out phase 2 by receiving the output 410 of the SoftMax layer of the classification network. In some implementations, for each set of prediction probabilities, the present sparse layer-wise training framework calculates entropy using the following equation:

$$E = - {\sum }_{c}^{\vert C \vert} {p}_{c} * log ( {p}_{c} )$$

where E stands for entropy, cϵC represents the available classes predicted by the classification network, and p_{c} represents the prediction probability/confidence for class c that was externalized in Phase 1. FIG. 4 shows that some embodiments of this Phase are performed by the Entropy-based Decider 420 and its computation.

Some existing solutions conventionally use entropy to create a drift detection mechanism based on data.

Based on this insight, the disclosed techniques have another use for entropy, leveraging the classification network batch prediction confidence to enhance the training procedure. Whenever a network is unsure which class the data is from, the output tends to have an even confidence score between all classes, reflecting, for example, high entropy. The reverse also tends to be true. This approach allows the present sparse layer-wise training framework to understand the likelihood that the current data has a complete set of different characteristics that the model is not used to, thereby exhibiting unwanted data drift.

### C.3 Phase 3—Select the Number of Layers to be Updated

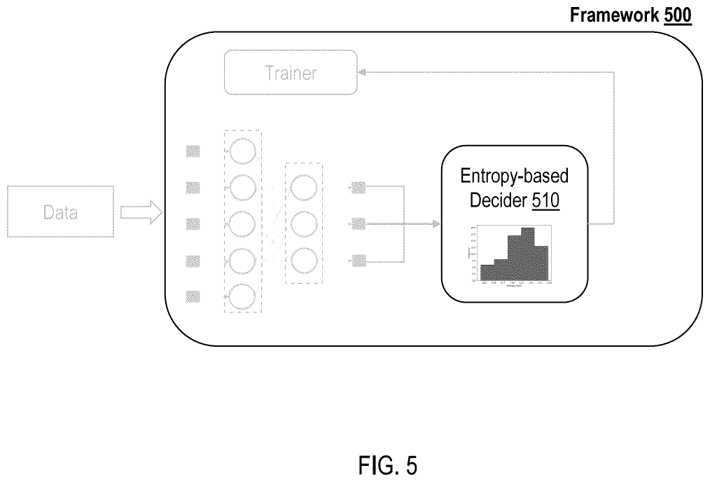

FIG. 5 shows aspects of an example layer count determination 500, in accordance with illustrative embodiments. In general, Phase 4 translates the entropy values into an appropriate output for the Trainer.

After computing the entropy values, example embodiments of the present framework deploy a mechanism to select the number of layers to be updated during Phase 3. In this case, the general goal is to dynamically select the number of layers to be trained based on the current computed entropy values. Therefore, the present framework leverages the Entropy-based Decider 510 for translating the entropy findings into a usable result for the Trainer, as shown in FIG. 5.

In example embodiments, the present mechanism considers that a high entropy value indicates that a deeper update is required. Therefore, in some implementations the number of layers to be updated is directly proportional to the entropy values. For example, the number of layers to be updated increases if the entropy is high, and decreases if the entropy is low.

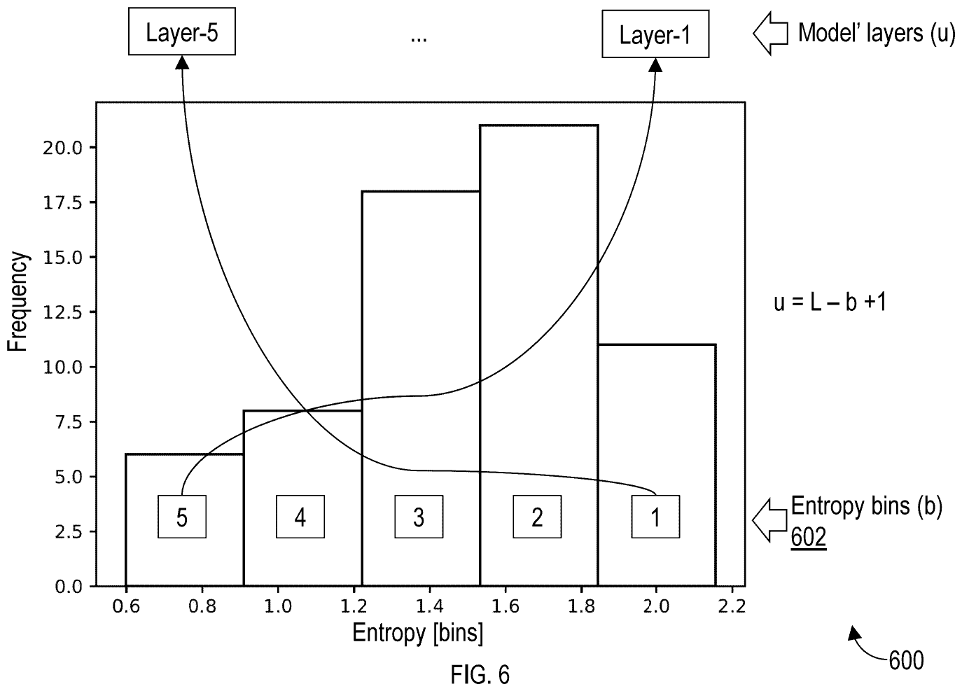

FIG. 6 shows aspects of an example entropy histogram 600, in accordance with illustrative embodiments. In general, FIG. 6 shows an example histogram of entropy for samples in a batch.

With reference to FIGS. 5 and 6, to illustrate the operation of the present framework, example embodiments create bins 602 based on the entropy values computed in Phase 2, as one example of an approach that can be used to take advantage of the output received from the Entropy-based Decider 510. In some implementations, the present framework first divides the entropy values into L buckets. Each bucket is labeled with an entropy value range. The Entropy Based Decider 510 proceeds to count the entropy values for all samples within the batch and put them into respective buckets.

FIG. 6 shows example output to illustrate this procedure. More particularly, FIG. 6 illustrates how an example final bucket segregation might look considering a data batch of an example CIFAR10 dataset. Considering this example, the Entropy-Based Decider selects the bucket with the highest count and returns it to the trainer. As depicted in FIG. 6, the return value for this Phase for the illustrated batch would be bucket 2 since that bucket exhibits the highest count on the histogram. In example embodiments, these buckets are then used to select the number of layers to be updated during Phase 4, which is described herein in further detail.

### C.4 Phase 4—Sparse Training Update

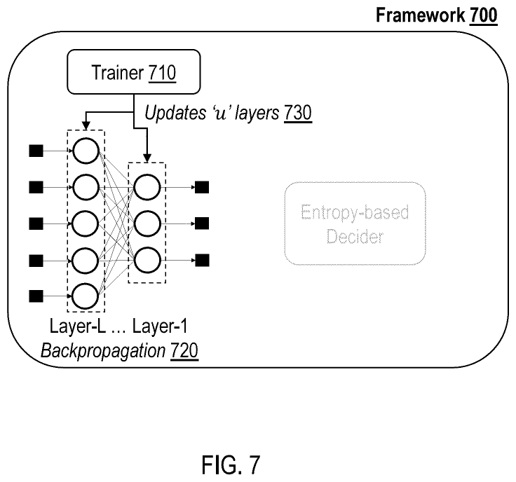

FIG. 7 shows aspects of an example sparse training 700, in accordance with illustrative embodiments. In general, FIG. 7 shows the Trainer 710 performing backpropagation 720 on u layers 730 of the network.

In example embodiments, Phase 4 starts the sparse training procedure. In some embodiments, the general approach is to update the parameters of the last u layers 730, where 1≤u≤L. Advantageously, whenever u<L, the framework 700 is storing fewer activations in memory and computing fewer updates during the backpropagation, which decreases both the memory and computational footprint.

With reference to FIGS. 6 and 7, some embodiments of this phase start by receiving the output from the mechanism responsible for deciding the number of layers to be updated during Phase 3. In the illustrated example, Phase 4 starts by receiving the bucket index of the highest bin value (e.g., Layer-2, as described in connection with FIG. 6 and Phase 3). In some implementations, the index represents the last u layers the module will execute backpropagation on. It should be noted that any procedure that dynamically converts the current entropy values into the expected value for the Trainer 710 can be used, without departing from the scope of the embodiments disclosed.

In general, the overall intuition is that in the presence of a drift, the prediction entropy values will be higher and u will be closer L accordingly. Since the incoming data is likely different from previous data, the model needs to be more aggressively updated. On the other hand, in case entropy is low, the data is likely the same as seen in past iterations, which means the disclosed techniques can avoid training the network in order to prevent model overfitting. Therefore, u values would be expected to be equal or close to 1, thereby leading to a shallow update and, consequently, resource usage reduction in terms of memory, computational power, and energy consumption.

As mentioned, during the forward pass, example embodiments of Phase 1 keep activations for only the last k layers. In some implementations, the Trainer 710 proceeds to evaluate if k≥u. In such case, the framework 700 has already saved any necessary intermediate activation for the current backpropagation using u layers. If k<u, then module starts a partial forward pass that will calculate the remaining u−k layer activations and proceed with the conventional backpropagation algorithm.

Example embodiments of the procedure complete by updating k←u for the next forward pass. By consistently updating k, the disclosed techniques take advantage of temporal locality, whereby similar data is likely to come by and decrease the occurrence of the case k<u, where additional activations are kept in memory.

It should be noted that example embodiments elect to start updates from the last layers, therefore u=1 updates only the last hidden layer from the network. Advantageously, in the presence of a consistent environment with low drift rate, the present solution is more likely to update only the final layers of the network which frequently have fewer parameters.

### C.5 Framework Benefits

The benefits of dynamically updating network layers are twofold. First, there is no need to keep intermediate activations during the forward pass for the layers that will not be trained, which implies a corresponding decrease in the memory footprint. Second, backward propagation and additional updates for L−u layers will not need to be computed which decreases computational costs (for example, but not limited to, memory, computational power, and energy consumption), which can help to introduce intelligence in highly resource-constrained devices. Moreover, by tying the choice of u and k with the entropy computation, the disclosed techniques can dynamically adapt the on-device training capabilities to avoid overfitting and, simultaneously, properly adapt to the changes that can frequently occur in dynamic environments. Advantageously, in this context, the present framework can be ported into any DNN model deployed at the edge that meets the various considerations discussed herein.

### D. Example Methods

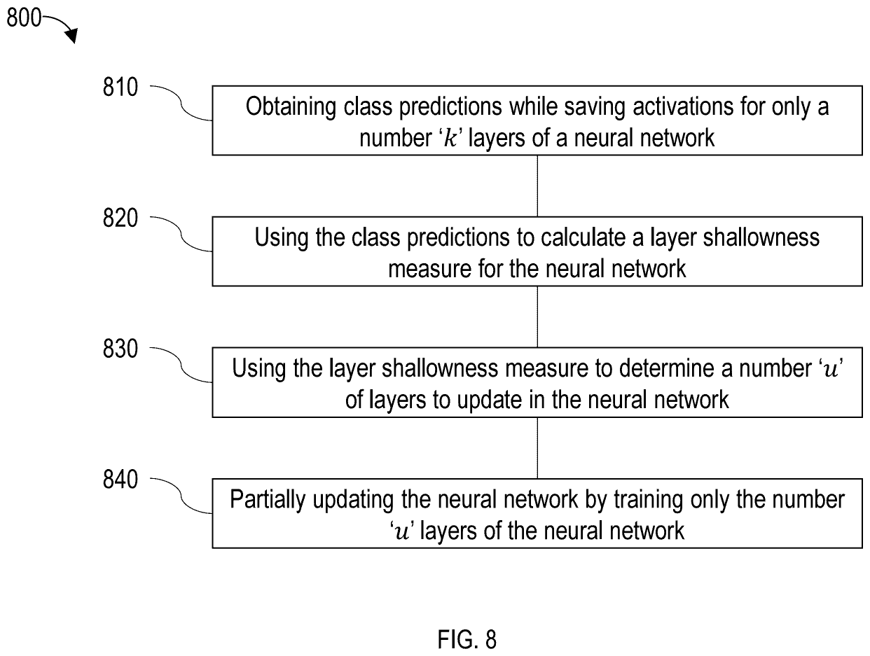

FIG. 8 shows a flowchart of an example method 800, in accordance with illustrative embodiments. In example embodiments, the method 800 allows for improved issue handling by identifying similar historical issues as references for a given issue.

In some embodiments, the method 800 can be performed by the sparse layer-wise training framework 100, 200, such as using the service 210.

In example embodiments, the method 800 includes obtaining class predictions while saving activations for only a number ‘k’ layers of a neural network (step 810). In some embodiments, activations are saved for the last ‘k’ layers of the neural network. In some embodiments, the neural network is a classifier model.

In example embodiments, the method 800 includes using the class predictions to calculate a layer shallowness measure for the neural network (step 820). In some embodiments, the layer shallowness measure is an adaptive partial model backpropagation measure. In further embodiments, the layer shallowness measure is determined dynamically as the neural network is retrained. In some embodiments, the layer shallowness measure is determined dynamically by detecting drift in the neural network. In further embodiments, the drift is detected using entropy values determined based on classes predicted by the neural network.

In example embodiments, the method 800 includes using the layer shallowness measure to determine a number ‘u’ of layers to update in the neural network (step 830). In some embodiments, the number ‘u’ of layers to update is determined using the entropy values. In further embodiments, the number ‘u’ of layers to update is determined by: dividing the entropy values into a plurality of ranges; and determining a count of entropy values that fall into each range.

In example embodiments, the method 800 includes partially updating the neural network by training only the number ‘u’ layers of the neural network (step 840). In some embodiments, ‘k’ and ‘u’ are fewer than all layers of the neural network. In some embodiments, the neural network is trained using sparse training to update the last ‘u’ layers of the neural network.

In some embodiments, the method 800 further includes, after partially updating the neural network, updating the number ‘k’ to have the value of the number ‘u’.

In example embodiments, the steps 810, 820, 830, 840 are performed on a resource-constrained device. In some embodiments, the resource-constrained device is an edge node of an edge network.

While the various steps in the example method 800 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 800 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

At least portions of the present sparse layer-wise training can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present sparse layer-wise training. For example, containers can be used to implement respective processing devices providing compute and/or storage services of a cloud-based system. Again, containers may be used in combination with other virtualization infrastructure such as virtual machines implemented using a hypervisor.

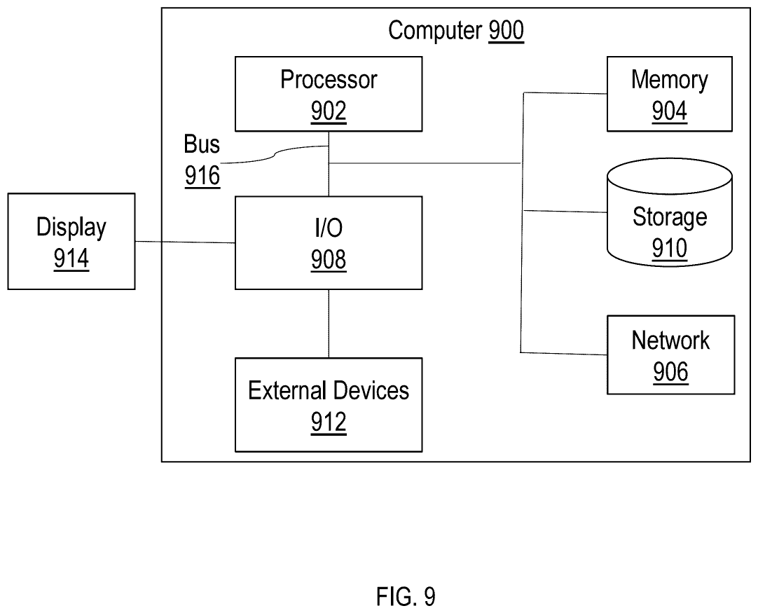

Illustrative embodiments of processing platforms will now be described in greater detail with reference to FIG. 9. Although described in the context of the present sparse layer-wise training, these platforms may also be used to implement at least portions of other information processing systems in other embodiments.

FIG. 9 illustrates aspects of a computing device or a computing system in accordance with example embodiments. The computer 900 is shown in the form of a general-purpose computing device. Components of the computer may include, but are not limited to, one or more processors or processing units 902, a memory 904, a network interface 906, and a bus 916 that communicatively couples various system components including the system memory and the network interface to the processor.

The bus 916 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 900 typically includes a variety of computer-readable media. Such media may be any available media that is accessible by the computer system, and such media includes both volatile and non-volatile media, removable and non-removable media.

The memory 904 may include computer system readable media in the form of volatile memory, such as random-access memory (RAM) and/or cache memory. The computer system may further include other removable/non-removable, volatile/non-volatile computer system storage media. By way of example only, the storage system 910 may be provided for reading from and writing to a non-removable, non-volatile magnetic media (not shown and typically called a “hard drive”) in accordance with the present sparse layer-wise training. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 916 by one or more data media interfaces. As has been depicted and described above in connection with FIGS. 1-8, the memory may include at least one computer program product having a set (e.g., at least one) of program modules that are configured to carry out the functions of the embodiments as described herein.

The computer 900 may also include a program/utility, having a set (at least one) of program modules, which may be stored in the memory 904 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 900 may also communicate with one or more external devices 912 such as a keyboard, a pointing device, a display 914, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 908. Still yet, the computer system may communicate with one or more networks such as a local area network (LAN), a general wide area network (WAN), and/or a public network (e.g., the Internet) via the network adapter 906. As depicted, the network adapter communicates with the other components of the computer system via the bus 916. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-9, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
at least one processing device including a processor coupled to a memory;
the at least one processing device being configured to implement the following steps:
obtaining class predictions while saving activations for only a number ‘k’ layers of a neural network;
using the class predictions to calculate a layer shallowness measure for the neural network;
using the layer shallowness measure to determine a number ‘u’ of layers to update in the neural network; and
partially updating the neural network by training only the number ‘u’ layers of the neural network.

2. The system of claim 1, wherein the layer shallowness measure is an adaptive partial model backpropagation measure.

3. The system of claim 2, wherein the layer shallowness measure is determined dynamically as the neural network is retrained.

4. The system of claim 1, wherein the layer shallowness measure is determined dynamically by detecting drift in the neural network.

5. The system of claim 4, wherein the drift is detected using entropy values determined based on classes predicted by the neural network.

6. The system of claim 5, wherein the number ‘u’ of layers to update is determined using the entropy values.

7. The system of claim 6, wherein the number ‘u’ of layers to update is determined by:
dividing the entropy values into a plurality of ranges; and
determining a count of entropy values that fall into each range.

8. The system of claim 1, wherein ‘k’ and ‘u’ are fewer than all layers of the neural network.

9. The system of claim 1, wherein the activations are saved for the last ‘k’ layers of the neural network.

10. The system of claim 1, wherein the neural network is trained using sparse training to update the last ‘u’ layers of the neural network.

11. The system of claim 1, wherein the at least one processing device is further configured to implement the following steps:
after partially updating the neural network, updating the number ‘k’ to have the value of the number ‘u’.

12. The system of claim 1, wherein the steps are performed on a resource-constrained device.

13. The system of claim 11, wherein the resource-constrained device is an edge node of an edge network.

14. The system of claim 1, wherein the neural network is a classifier model.

15. A method comprising:
obtaining class predictions while saving activations for only a number ‘k’ layers of a neural network;
using the class predictions to calculate a layer shallowness measure for the neural network;
using the layer shallowness measure to determine a number ‘u’ of layers to update in the neural network; and
partially updating the neural network by training only the number ‘u’ layers of the neural network.

16. The method of claim 15, wherein the layer shallowness measure is an adaptive partial model backpropagation measure.

17. The method of claim 16, wherein the layer shallowness measure is determined dynamically as the neural network is retrained.

18. The method of claim 15, wherein the layer shallowness measure is determined dynamically by detecting drift in the neural network.

19. The method of claim 18, wherein the drift is detected using entropy values determined based on classes predicted by the neural network.

20. A non-transitory processor-readable storage medium having stored thereon program code of one or more software programs, wherein the program code when executed by at least one processing device causes the at least one processing device to perform the following steps:
obtaining class predictions while saving activations for only a number ‘k’ layers of a neural network;
using the class predictions to calculate a layer shallowness measure for the neural network;
using the layer shallowness measure to determine a number ‘u’ of layers to update in the neural network; and
partially updating the neural network by training only the number ‘u’ layers of the neural network.
